(19) United States
(12) Patent Application Publication
(10) Pub. No.: US 2020/0113406 A1
(43) Pub. Date: Apr. 16, 2020

(54) METHOD FOR REMOVING A DEPOSITION OF SCALE ON A HEATING ELEMENT AND A HOUSEHOLD APPLIANCE CONFIGURED TO PERFORM THE METHOD

(71) Applicant: ELECTROLUX APPLIANCES AKTIEBOLAG, Stockholm (SE)

(72) Inventors: Vendela TÖRNQUIST, Stockholm (SE); Johan WALDEBÄCK, Stockholm (SE)

(21) Appl. No.: 16/500,864

(22) PCT Filed: Apr. 28, 2017
(86) PCT No.: PCT/EP2017/060207

§ 371 Date: Oct. 4, 2019

(51) Int. Cl. A47L 15/00; F24H 9/00; H05B 1/02; D06F 39/04; A47L 15/42

(52) U.S. Cl. CPC A47L 15/0057; F24H 9/0042; H05B 1/0252; A47L 2401/34; A47L 15/4285; D06F 2202/04; A47L 2401/20; D06F 39/04

(57) ABSTRACT

A method for removing a deposition of scale on a heating element may include turning on the heating element to heat the liquid in the heating space, determining a first value (Tv1) of temperature of the heating element and/or a first time period (tp1) during heating of the liquid. The method may further include turning off the heating element and turning on the heating element at a second value (Tv2) of temperature of the heating element and reheating the liquid in the heating space until temperature of the heating element reaches a third value (Tv3) related to the first value (Tv1) and/or until a second time period (tp2) related to the first time period (tp1) is reached. A household appliance may also be provided.

### TECHNICAL FIELD

Embodiments herein relate to a method for removing a deposition of scale on a heating element and especially to a method for removing a deposition of scale on a heating element arranged in a household appliance and to a household appliance configured to perform the method.

### BACKGROUND

Water heating elements in household appliances, as for example dishwashers or washing machines, are used for heating water to some desired temperature suitable for use in the household appliance.

In areas where a heating element contacts water, scale will tend to form on the heating element such that a layer of scale is accumulated over time which slowly reduces the heating ability of the heating element. This is particularly the case in areas where the water supplied is so-called hard water, i.e. water containing some percentage of calcium and magnesium carbonates, bicarbonates, sulphates or chlorides due to long contact with rocky substrates.

Scale formed on a heating element makes the element less efficient and may further result in permanent damage of the heating element. This can be avoided by descaling the heating element once it can be detected that scale is present on the heating element.

According to a conventional method for descaling of a heating element, the heating element is exposed for vibrations that may for example be caused by ultrasonic waves.

U.S. Pat. No. 8,882,346 describes another method for removing calcareous depositions from a resistance by heating the resistance to a temperature higher than an operating temperature of the resistance while the resistance is kept above a washing liquid. After heating the resistance is turned off.

However, the known methods as above are not very accurate and reliable and require vibrating of a heating element or heating a heating element to temperatures that may cause damage of the heating element.

### SUMMARY

An object of the embodiments herein to provide an improved method for removing a deposition of scale on a heating element comprised in the household appliance.

According to an aspect, a method is provided for removing a deposition of scale on a heating element arranged to heat a liquid in a heating space of a household appliance.

Because, the heating element is arranged to heat the liquid in the heating space a transfer of thermal energy between the heating element and the liquid is possible. The liquid may for example be water. The water may be drinking water.

The method comprises turning on the heating element to heat the liquid in the heating space and determining a first value of temperature of the heating element and/or a first time period during heating of the liquid.

Thus, during heating of the liquid a reference value of temperature of the heating element and/or a reference time period is determined. With other words the first value of temperature of the heating element represents a reference value of temperature of the heating element and the first time period represents a reference time period to be used in the method described herein.

The method further comprises turning off the heating element and turning on the heating element at a second value of temperature of the heating element and reheating the liquid in the heating space until temperature of the heating element reaches a third value related to the first value and/or until a second time period related to the first time period is reached.

Each time the heating element is turned on the temperature of the heating element increases and each time the heating element is turned off the temperature of the heating element decreases. Thereby, by turning on and off the heating element a temperature oscillation of temperature of the heating element is achieved. Thus, the heating element is exposed to a temperature variation by turning on, turning off and turning on the heating element again.

The third value of temperature of the heating element is related to the first value, i.e. there is a correlation between the third value and the first value. With other words the third value depends on the first value and may be controlled depending on the first value.

In a similar way the second time period is related to the first time period, i.e. there is a correlation between the second time period and the first time period. With other words the second time period depends on the first time period and may be controlled depending on the first time period.

Consequently, by turning on the heating element, turning off the heating element and turning on the heating element again said heating element is exposed to an oscillation cycle of temperature of the heating element, i.e. a heating-cooling cycle, causing a deposition of scale on the heating element to fall off. Further, because the third value of temperature of the heating element is related to the first value of temperature of the heating element and the second time period is related to the first time period said oscillation, i.e. variation of temperature of the heating element is accomplished between values of temperature of the heating element that relate to each other and/or during time periods that relate to each other. By this, a deposition of scale on a heating element is removed in a simple, efficient and controllable manner. Thus, an improved method for removing a deposition of scale on a heating element is provided.

As a result, the above mentioned object can be achieved.

According to some embodiments the first value of temperature of the heating element corresponds to a boiling temperature of the liquid and the first time period is required to reach the boiling temperature of the liquid.

Because the first value of temperature of the heating element corresponds to the boiling temperature of the liquid the third value of temperature of the heating element is correlated with the boiling temperature of the liquid. In a similar way the second time period, relating to the first time period, is correlated with a time period required to reach temperatures of the heating element that is associated with boiling temperature of the liquid. Thus, the heating element is heated up to temperatures around values corresponding to the boiling temperature of the liquid i.e. values of temperature of the heating element that cause start boiling or boiling of the liquid. With start boiling is meant a condition of the liquid when a movement of the liquid in the vicinity of the heating element is caused and/or when first bubbles are created. Thus, the heating element is exposed to a heating-cooling cycle causing a movement of the liquid in the vicinity of the heating element, which movement of the liquid contributes to removing of a deposition of scale on the heating element.

Thereby, a deposition of scale on a heating element is removed in a simple manner and without need of heating the heating element to high temperatures that may cause damage of the heating element.

Thus, a further improved method for removing a deposition of scale on a heating element is provided.

The method may comprise monitoring a behaviour of temperature of the heating element during heating of the liquid in order to determine the first value of temperature of the heating element and/or in order to determine the first time period.

The behaviour, which may also be called characteristic of measured temperature of the heating element, describes how the temperature of the heating element changes during heating of the liquid in the heating space. In other words, the behaviour illustrates how the heating element reacts during heating of the liquid. Thus, properties and conditions of the heating element may thereby be described by determining and analyzing the behaviour of the temperature of the heating element during heating of the liquid.

The behaviour is obtained by measuring values of temperature of the heating element which measured values of the temperature may be illustrated as a plot or a chart, for example a line chart.

Further, the behaviour of the temperature of the heating element during heating of the liquid may be used to determine the first value of temperature of the heating element and/or to determine the first time period. Because the first value of temperature of the heating element may correspond to the boiling temperature of the liquid and the first time period may be required to heat the liquid to the boiling temperature of the liquid, the boiling temperature of the liquid and the time required to reach the boiling temperature of the liquid may be determined in a simple manner by analyzing the behaviour of the temperature of the heating element during heating of the liquid.

As an alternative the method comprises repeating at least once the turning off the heating element and the turning on the heating element at the second value of temperature of the heating element and reheating the liquid in the heating space until temperature of the heating element reaches the third value related to the first value and/or until the second time period related to the first time period is reached. By repeating at least once, for example several times, the turning off and on of the heating element, the heating element is exposed to several oscillation cycles of temperature of the heating element, i.e. heating-cooling cycles. By this a further improved method for removing a deposition of scale on a heating element is provided.

Further, the method may comprise obtaining a start temperature of the heating element before turning on the heating element. Thus, a temperature of the heating element when the heating element is cold, i.e. not heated up, is achieved. The start temperature of the heating element may be equal to the liquid start temperature before turning on the heating element. Thus, the liquid start temperature may be obtained by obtaining the start temperature of the heating element.

According to some embodiments the third value of temperature of the heating element constitutes a first predetermined percentage of the first value of temperature of the heating element, i.e. the third value is calculated as the first predetermined percentage of the first value. Thereby, the third value is related to the first value by the first predetermined percentage of the first value used for calculating the third value. With other words the third value depends on the first value because the third value constitutes said first predetermined percentage of the first value.

Further, a third time period constitutes a second predetermined percentage of the first time period, wherein the third time period is calculated as a sum of a fourth time period required to heat the heating element, during heating of the liquid in the heating space, from the start temperature to the second value of the temperature of the heating element and of the second time period. Thereby, the sum of the fourth time period and of the second time period constitutes the second predetermined percentage of the first time period. Thus, the second time period is related to the first time period by being comprised in the third time period, which third time period is calculated as said second predetermined percentage of the first time period.

The first predetermined percentage and the second predetermined percentage may be between 90% and 110%.

As an alternative the heating element is turned on at the second value of temperature of the heating element if the second value is lower than the first value with a third predetermined percentage of the first value of temperature of the heating element. Thereby, the heating element is turned on after the heating element has cooled down to the second value of temperature of the heating element.

The third predetermined percentage may be at least 10%.

Further, the method may comprise removing the liquid from the heating space. Thus, the deposition of scale that has been removed from the heating element will be transported out from the heating space.

Another object of the embodiments herein is to provide an improved household appliance configured to perform the improved method for removing a deposition of scale on a heating element comprised in the household appliance. The method has been described above.

According to another aspect, a household appliance is provided which comprises a heating element which is arranged to heat a liquid in a heating space of the household appliance, a sensor arranged to measure temperature of the heating element and a control unit, wherein the household appliance being configured to turn on the heating element to heat the liquid in the heating space, determine a first value of temperature of the heating element and/or a first time period during heating of the liquid, turn off the heating element and turn on the heating element at a second value of temperature of the heating element and reheat the liquid in the heating space until temperature of the heating element reaches a third value related to the first value and/or until a second time period related to the first time period is reached.

Thereby, an improved household appliance is provided configured to remove a deposition of scale on a heating element comprised in the household appliance in a simple and efficient way.

As a result, the above mentioned object can be achieved.

Optionally, the household appliance may further be configured to perform the alternative steps in the method as described above.

Further features and advantages of the embodiments herein will become apparent when studying the appended claims and the following detailed description. Those skilled in the art will realize that the different features described may be combined to create embodiments other than those described in the following, without departing from the scope defined by the appended claims.

### BRIEF DESCRIPTION OF THE DRAWINGS

The various aspects mentioned above, including their particular features and advantages, will be readily understood from the following detailed description and the accompanying drawings, in which:

FIG. 1 is a flow chart illustrating a method for removing a deposition of scale on a heating element,

FIG. 2 is a diagram illustrating behaviour of temperature of a heating element during implementing of some steps of the method in FIG. 1 and

FIG. 3 is a plane view of a household appliance.

### DETAILED DESCRIPTION

The embodiments herein will now be described in more detail with reference to the accompanying drawings, in which example embodiments are shown. Disclosed features of example embodiments may be combined. Like numbers refer to like elements throughout. Well-known functions or constructions will not necessarily be described in detail for brevity and/or clarity.

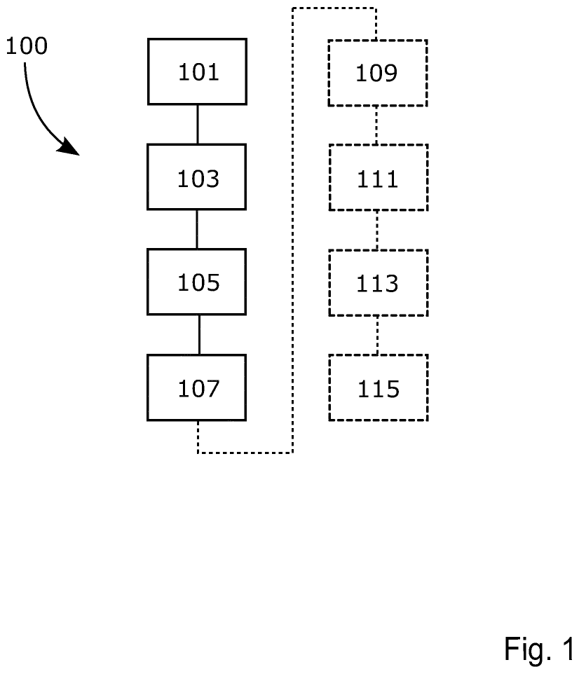

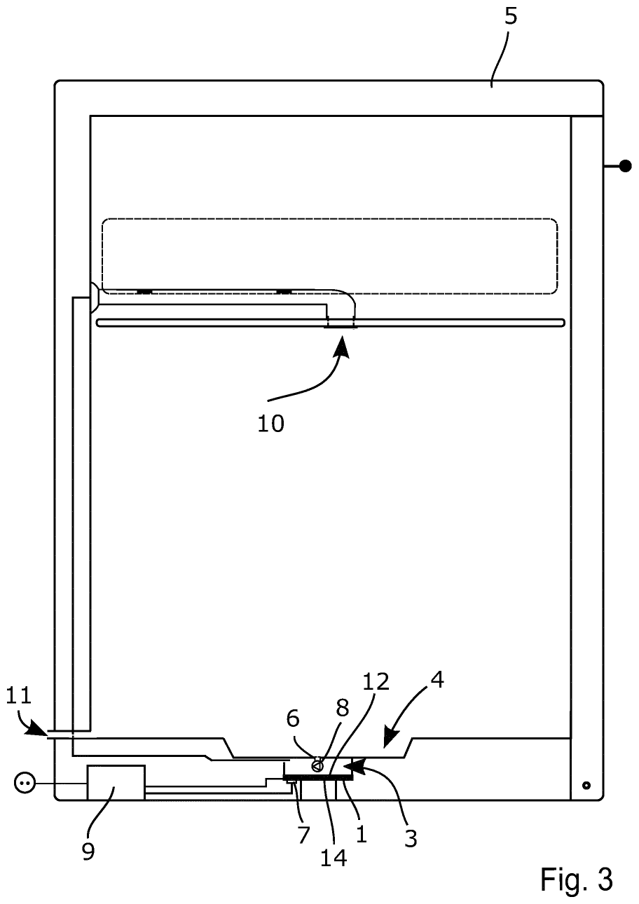

FIG. 1 illustrates an example of actions in a procedure for implementing a method 100 for removing a deposition of scale on a heating element in a heating space of a household appliance. The method 100 may for example be carried by a control unit connected to or arranged at the household appliance. Such a control unit is shown in FIG. 3 and its function will be described in details in conjunction to description of FIG. 3. In conjunction to the FIG. 3 also other details of the household appliance and theirs function for the method will be described.

The method 100 comprises: turning on 101 the heating element to heat the liquid in the heating space, determining 103 a first value of temperature of the heating element and/or a first time period during heating of the liquid, turning off 105 the heating element and turning on 107 the heating element at a second value of temperature of the heating element and reheating the liquid in the heating space until temperature of the heating element reaches a third value related to the first value and/or until a second time period related to the first time period is reached.

The liquid may for example be water or water comprising a detergent.

The method 100 may comprise monitoring 109 a behaviour of temperature of the heating element during heating of the liquid in order to determine the first value of temperature of the heating element and/or in order to determine the first time period.

The behaviour is obtained by measuring values of temperature of the heating element. The temperature of the heating element may be measured using a sensor arranged at the heating element. The sensor is described in details in conjunction to FIG. 3.

Further, the method 100 may comprise: repeating 111 at least once the turning off 105 the heating element and the turning on 107 the heating element at the second value of temperature of the heating element and reheating the liquid in the heating space until temperature of the heating element reaches the third value related to the first value and/or until the second time period related to the first time period is reached.

The method 100 may also comprise obtaining 113 a start temperature of the heating element before turning on 101 the heating element and removing 115 the liquid from the heating space.

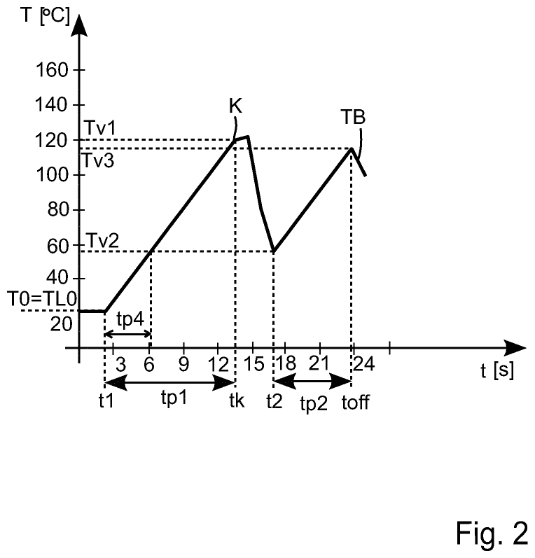

FIG. 2 is a diagram illustrating a behaviour TB of temperature T of a heating element, which temperature T is measured by a sensor.

A start temperature T0 of the heating element is measured before turning on the heating element at a first point in time t1 and after the liquid has been supplied to the heating space. According to some embodiments the start temperature T0 may be measured after for example 10 seconds from supplying of the liquid to the heating space. After this time, i.e. for example 10 seconds the liquid in the heating space will reach steady state which means that there is essentially no movement of the liquid within the heating space resulting in that temperature of the liquid and temperature of the heating element reach an average value common both for the heating element and the liquid in the heating space. Therefore, by measuring the start temperature T0 of the heating element before turning on of the heating element a liquid start temperature T0L may be achieved. According to the example illustrated in FIG. 2 the start temperature T0 of the heating element has been measured to 20° C. Thus, the liquid start temperature T0L is also 20° C.

At the first point in time t1 the heating element is turned on to heat the liquid and simultaneously a first time period tp1 from the first point in time t1 is started to be measured by a time measuring device.

During heating of the liquid in the heating space the behaviour TB of the measured temperature T of the heating element is monitored i.e. is studied in order to determine a first value Tv1 of the temperature of the heating element and/or the first time period tp1. The first value Tv1 of temperature of the heating element corresponds to a boiling temperature of the liquid and the first time period tp1 is required to heat the liquid to said boiling temperature of the liquid.

The temperature T of the heating element increases from the start temperature T0 with approximately a constant derivate up to the first value Tv1. In the example shown in FIG. 2 the first value is approximately 120° C.

When a liquid heated by a heating element starts boiling the temperature of the heating element continues to increase with a different derivate than up to start boiling. With start boiling of the liquid is meant for example when first air bubbles begin to be formed in the direct vicinity of the heating element.

Thus, a temperature of the heating element corresponding to start boiling temperature of the liquid may be determined by detecting a boiling point at behaviour of the temperature of the heating element, which boiling point is detected by monitoring the behaviour. FIG. 2 illustrates a boiling point K corresponding to the first value Tv1 of temperature T of the heating element.

Start boiling of the liquid in the heating space i.e. boiling point K at the behaviour TB occurs at a boiling time tk. The measured time period from the first point in time t1 to the boiling time tk define the first time period tp1.

After the boiling point K has been detected the heating element is turned off. The heating element may be turned off for example after 2 second from detecting boiling point K. As can be seen in FIG. 2, the temperature T of the heating element decreases after the heating element has been turned off.

Further, the heating element is turned on at a second point in time t2 and at a second value Tv2 of the temperature T of the heating element. The heating element is turned on when temperature of the heating element T has decreased to the second value Tv2 which second value Tv2 is lower than the first value Tv1 with a third predetermined percentage of the first value Tv1, for example with at least 10% of the first value Tv1 of temperature of the heating element. With other words, the heating element is turned on when temperature T of the heating element has decreased with at least 10% of the first value Tv1 of temperature of the heating element.

The liquid is then reheated and simultaneously a second time period tp2 from the second point in time t2 is started to be measured.

The first time period tp1 and the second time period tp2 are measured by a time measuring device that may be comprised in a control unit described in conjunction to FIG. 3.

The liquid is reheated in the heating space until a third value Tv3 related to the first value Tv1 is reached. According to embodiments illustrated in FIG. 2 the third value Tv3 corresponds to approximately 90% of the first value Tv1 of temperature of the heating element, which third value Tv3 is approximately 108° C.

Alternatively, the liquid in the heating space is reheated until the second time period tp2 related to the first time period tp1 is reached. The second time period tp2 is related to the first time period tp1 by being comprised in a third time period and by a second predetermined percentage used to calculate the third time period so that the third time period constitutes the second predetermined percentage of the first time period. According to FIG. 2, the second predetermined percentage is approximately 90%.

The third time period is calculated by a control unit as a sum of the second time period tp2 a fourth time period tp4 according to equation (1) below:

tp3=tp2+tp4 (1)

Where, the fourth time period tp4 is a time period that is required to heat the heating element during heating of the liquid in the heating space without interruption from the first point in time t1 and from the start temperature T0 to the second value Tv2 of the temperature of the heating. With other words the heating element is not turned off when determining the fourth time period tp4.

When the third value Tv3 of temperature of the heating element has been reached and/or when the second time period tp2 has been reached, the heating element is turned off at an off-point in time toff and the temperature T of the heating element decreases again.

It has been observed that by implementing a heating-cooling cycle of a heating element which heating-cooling cycle is at least partly illustrated by the behaviour TB in FIG. 2 a deposition of scale on the heating element is removed in a simple and effective manner and without need of heating the heating element to high temperatures that may cause damage of the heating element.

After the heating element has been turned off, at said off-point in time toff, it may be turned on again when the temperature T of the heating element has decreased to the second value Tv2.

Thus, by repeating at least once, for example several times, the turning off and on of the heating element, the heating element is exposed to several oscillation cycles of temperature of the heating element, i.e. heating-cooling cycles or shift of temperature cycles. By this a further improved method for removing a deposition of scale on a heating element is provided.

When repeating the turning off and on of the heating element the first predetermined percentage may be equal or different each time the repeating procedure is performed. In a similar way the second predetermined percentage and the third predetermined percentage may be equal or different each time the repeating procedure is performed.

FIG. 3 illustrates an example of a household appliance which may be a dishwasher 5 comprising a heating element 1 arranged to heat a liquid in a heating space 3 of the dishwasher 5. Further the dishwasher 5 comprises a sensor 7 arranged to measure temperature of the heating element 1. The dishwasher 5 comprises also a control unit 9.

The heating space 3 that may also be called heating cavity is connected to a sump 4 of the dishwasher 5 by a channel 6 enabling transport of the liquid from the sump 4 to the heating space 3. This may be achieved by a pump 8 arranged to transport the liquid from the sump to the heating space 3. As illustrated in the example in FIG. 3, the pump 8, which may be any suitable pump for pumping liquid, may be arranged within the heating space 3.

The sump 4 is arranged to receive the liquid supplied to the dishwasher 5 through an inlet 11. The inlet 11 may be connected to a pipe network (not shown) for supplying water.

The heating element 1 is arranged to heat the liquid in the heating space 3, i.e. the heating element 1 is arranged in the heating space 3 so that a transfer of thermal energy between the liquid supplied to the heating space 3 and the heating element 1 is possible and sufficient for example for heating the liquid for use in the dishwasher 5. In a normal use the liquid is heated by the heating element 1 to about 70-80° C. The heating element 1 may be arranged to have direct contact with the liquid supplied to the heating space.

During an operation of the dishwasher 5, water is heated by the heating element 1 and is then pumped to a wash arm arrangement 10 of the dishwasher 5. The heating element 1 is connected to a power grid through the control unit 9. The heating of the heating element 1 is electrical and is achieved in a regular manner, which is therefore not necessary to described in detail.

The control unit 9 is connected to the sensor 7, which may be a temperature sensor of any suitable kinds. The control unit 9 is arranged to receive information data regarding temperature measured by the sensor 7. Further, the control unit 9 is arranged to process the information data from the sensor 7 in order to create behaviour of temperature of the heating element. The behaviour is shown in FIG. 2. Further the control unit 9 is arranged to enable monitoring i.e. evaluating of the behaviour of the temperature of the heating element.

The control unit 9 may further comprise a voltage measuring device (not shown), as for example an ADC, and a time measuring device, as for example a crystal oscillator (not shown). The control unit 9 may also comprise a voltage adapting means (not shown) for adjusting voltage to the heater.

According the embodiments in FIG. 3 the sensor 7 is arranged to measure temperature of the heating element 1. The sensor 7 may be arranged at a distance from the heating element 1, which distance enables sufficient measurement of temperature of the heating element 1. As illustrated in FIG. 3 the sensor 7 may be arranged directly on a surface of the heating element 1. If the heating element 1 is arranged to have contact with the liquid supplied to the heating space 3, for example by a first surface 12 the sensor 7 is arranged on a second surface 14 of the heating element 1, which second surface 14 does not have contact with the liquid supplied to the heating space 3. The sensor 7 may for example be attached to the second surface 14 by an adhesive.

1. A method for removing a deposition of scale on a heating element arranged to heat a liquid in a heating space of a household appliance, the method comprises:
a) turning on the heating element to heat the liquid in the heating space,
b) determining a first value (Tv1) of temperature of the heating element and/or a first time period (tp1) during heating of the liquid,
c) turning off the heating element and
d) turning on the heating element at a second value (Tv2) of temperature of the heating element and reheating the liquid in the heating space until temperature of the heating element reaches a third value (Tv3) related to said first value (Tv1) and/or until a second time period (tp2) related to said first time period (tp1) is reached.

2. The method according to claim 1, wherein said first value (Tv1) of temperature of the heating element corresponds to a boiling temperature of the liquid and said first time period (tp1) is required to reach said boiling temperature of the liquid.

3. The method according to claim 1 further comprising monitoring a behavior (TB) of temperature of the heating element during heating of the liquid in order to determine said first value (Tv1) of temperature of the heating element and/or in order to determine said first time period (tp1).

4. The method according to claim 1 further comprising:
repeating said step c) and d) at least once.

5. The method according to claim 1 further comprising obtaining a start temperature (T0) of the heating element before turning on the heating element.

6. The method according to claim 5, wherein said third value (Tv3) of temperature of the heating element constitutes a first predetermined percentage of said first value (Tv1) of temperature of the heating element, and/or a third time period (tp3) constitutes a second predetermined percentage of said first time period (tp1), wherein said third time period is calculated as a sum of a fourth time period (tp4) required to heat said heating element, during heating of the liquid in the heating space, from the start temperature (T0) to said second value (Tv2) of the temperature of the heating element and of said second time period (tp2).

7. The method according to claim 6, wherein said first predetermined percentage and said second predetermined percentage is between 90% and 110%.

8. The method according to claim 1, wherein the heating element is turned on at the second value (Tv2) of temperature of the heating element if said second value (Tv2) is lower than said first value (Tv1) with a third predetermined percentage of said first value (Tv1) of temperature of the heating element.

9. The method according to claim 8 wherein said third predetermined percentage is at least 10%.

10. The method according to claim 1 further comprising removing the liquid from said heating space.

11. A household appliance comprising a heating element arranged to heat a liquid in a heating space of said household appliance, a sensor arranged to measure temperature of said heating element and a control unit, wherein the household appliance being configured to:
turn on the heating element to heat the liquid in the heating space,
determine a first value (Tv1) of temperature of the heating element and/or a first time period (tp1) during heating of the liquid,
turn off the heating element and
turn on the heating element at a second value (Tv2) of temperature of the heating element and reheat the liquid in the heating space until temperature of the heating element reaches a third value (Tv3) related to said first value (Tv1) and/or until a second time period (tp2) related to said first time period (tp1) is reached.

12. The household appliance according to claim 11, wherein said first value (Tv1) of temperature of the heating element corresponds to a boiling temperature of the liquid and said first time period (tp1) is required to reach said boiling temperature of the liquid.

13. The household appliance according to claim 11, further being configured to monitor a behaviour (TB) of temperature of the heating element during heating of the liquid in order to determine said first value (Tv1) of temperature of the heating element and/or in order to determine said first time period (tp1).

14. The household appliance according to claim 11 further being configured to repeat at least once the turning off the heating element and the turning on the heating element at the second value (Tv2) of temperature of the heating element, and reheat the liquid in the heating space until temperature of the heating element reaches the third value (Tv3) related to said first value (Tv1) and/or until the second time period (tp2) related to said first time period (tp1) is reached.

15. The household appliance according to claim 11, further being configured to obtain a start temperature (T0) of the heating element before turning on the heating element.

16. The household appliance according to claim 15, wherein said third value (Tv3) of temperature of the heating element constitutes a first predetermined percentage of said first value (Tv1) of temperature of the heating element, and/or a third time period (tp3) constitutes a second predetermined percentage of said first time period (tp1), wherein said third time period is calculated as a sum of a fourth time period (tp4) required to heat said heating element, during heating of the liquid in the heating space, from the start temperature (T0) to said second value (Tv2) of the temperature of the heating element and of said second time period (tp2).

17. The household appliance according to claim 16, wherein said first predetermined percentage and said second predetermined percentage is between 90% and 110%.

18. The household appliance according to claim 11, wherein the heating element is turned on at the second value (Tv2) of temperature of the heating element if said second value (Tv2) is lower than said first value (Tv1) with a third predetermined percentage of said first value (Tv1) of temperature of the heating element.

19. The household appliance according to claim 18 wherein said third predetermined percentage is at least 10%.

20. The household appliance according to claim 11, further being configured to remove the liquid from said heating space.
